(19) United States
(12) Patent Application Publication
(10) Pub. No.: US 2008/0246630 A1
(43) Pub. Date: Oct. 9, 2008

(54) Method and equipment for illuminating a school safety zone

(76) Inventors: William E. Rosemeyer, Gibsonia, PA (US); Thomas G. Buckner, Gibsonia, PA (US)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(21) Appl. No.: 12/077,943

(22) Filed: Mar. 20, 2008

Related U.S. Application Data
(60) Provisional application No. 60/921,779, filed on Apr. 3, 2007.

(51) Int. Cl. G08G 1/09

(52) U.S. Cl. 340/907

(57) ABSTRACT

A system for indicating along a length of a roadway that a reduced speed limit is in force, as e.g. in a school safety zone on days when school is in session. The system provides patterns of illumination along one or more portions of the length of the roadway, patterns of varying intensity and/or color unusual enough to draw the attention of a motorist.

### CROSS REFERENCE TO RELATED APPLICATIONS

Reference is made to and priority claimed from U.S. provisional application Ser. No. 60/921,779, filed Apr. 3, 2007, entitled METHOD AND EQUIPMENT FOR ILLUMINATING A SCHOOL SAFETY ZONE.

### BACKGROUND OF THE INVENTION

1. Technical Field

The present invention pertains to the field of illumination and also to the field of road signage and signaling, and more particularly to illumination for signifying a school safety zone.

2. Discussion of Related Art

A school (safety) zone is typically indicated today by an entry sign at the entrance to a school zone warning a motorist of the school zone and using flashing yellow lights to indicate when a reduced speed limit is in force. At the other end of the school zone, an exit sign is positioned to signal to the motorist the end of the school zone.

Sometimes the entry sign and the exit sign are a considerable distance, and so sometimes there is a tendency for drivers to speed up before leaving the school zone. Also, and again especially when the school zone extends over an appreciable length of road, there are intersecting roads from which a motorist can enter the school zone and not pass by the entry sign for the school zone, and so not be aware that a reduced speed limit is in force.

What is needed is a way to be able to ensure that motorists have notice, at any time and at any location along a roadway, of whether the location has a reduced speed limit at the time.

### DISCLOSURE OF INVENTION

Accordingly, in a first aspect of the invention, a system is provided for indicating where along a length of road a reduced speed limit is in force, comprising: a plurality of lights, disposed from place to place along the length of road and embedded in the road, and whose illumination when turned on varies in some characteristic; and a trigger, for turning the lights on when the reduced speed limit is in force.

In accord with the first aspect of the invention, the lights may be connected by conductors to each other and to a tap of external electric power serving as the trigger.

Also in accord with the first aspect of the invention, the lights may be solar powered and radio-controlled by a transmitter serving as the trigger.

Further in accord with the first aspect of the invention, the varying of some characteristic may be a varying of intensity.

Still further in accord with the first aspect of the invention, the varying of some characteristic may be a varying of color.

### BRIEF DESCRIPTION OF THE DRAWINGS

The above and other objects, features and advantages of the invention will become apparent from a consideration of the subsequent detailed description presented in connection with accompanying drawings, in which:

FIG. 1 is a schematic diagram of a system for use in signifying a reduced speed limit is in force in e.g. a school safety zone, according to an embodiment of the invention in which electric power is provided from an external source.

FIG. 2 is a schematic diagram of a system for use in signifying a reduced speed limit is in force in e.g. a school safety zone, according to an embodiment of the invention in depending on solar power.

### DETAILED DESCRIPTION

The invention provides positive notice to a motorist when the motorist is in a zone where a reduced speed limit is in force, as e.g. in a school zone on a school day.

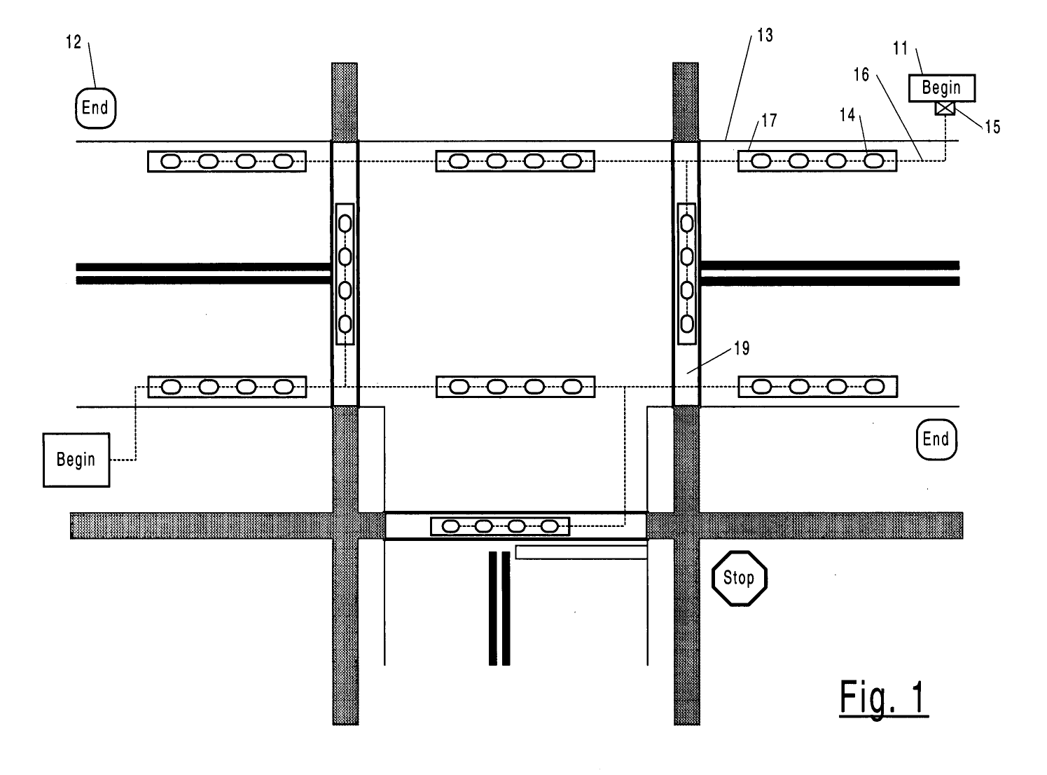

Referring now to FIG. 1, and taking as an example a school zone, according to the prior art when a motorist enters a school zone along a road 13 there is typically a “begin” (school zone) sign 11 indicating the beginning of the school zone, and if it is a school day and it is a time of day when the speed limit is reduced, blinking lights attached to or associated with the school zone sign are turned on. The motorist then continues along the length of the school zone without any further indication as to whether the motorist is still located in the school zone until reaching an “end” (school zone) sign 12. Also, if a motorist enters from a side street, there may not be any indication to the motorist that the motorist is entering the school zone.

According to the invention, to address these concerns lights 14 in a protective casing 17 having a transparent cover are embedded in the road along the length of the road, preferably slightly recessed to avoid being damaged by snow plowing. Electric power is preferably obtained by tapping the power line providing light to the entry sign 11 using a tap 15. The lights are connected to the entry sign power line (not shown) by conductors 16 arranged in a circuit in the same manner as Christmas tree lights, i.e. in series, but so that a light bulb burning out does not prevent electric power from reaching other lights in the circuit.

In embodiments in which the electric power is provided by tapping the power line providing power to the entry sign 11, the tap 15 is attached at a tap point picked so that power is provided to the lights 14 only when power is turned on for the lights of the entry sign. The tap 15 at the entry sign therefore acts as a trigger, i.e. it turns the lights 14 on when and only when the lights of the entry sign turn on.

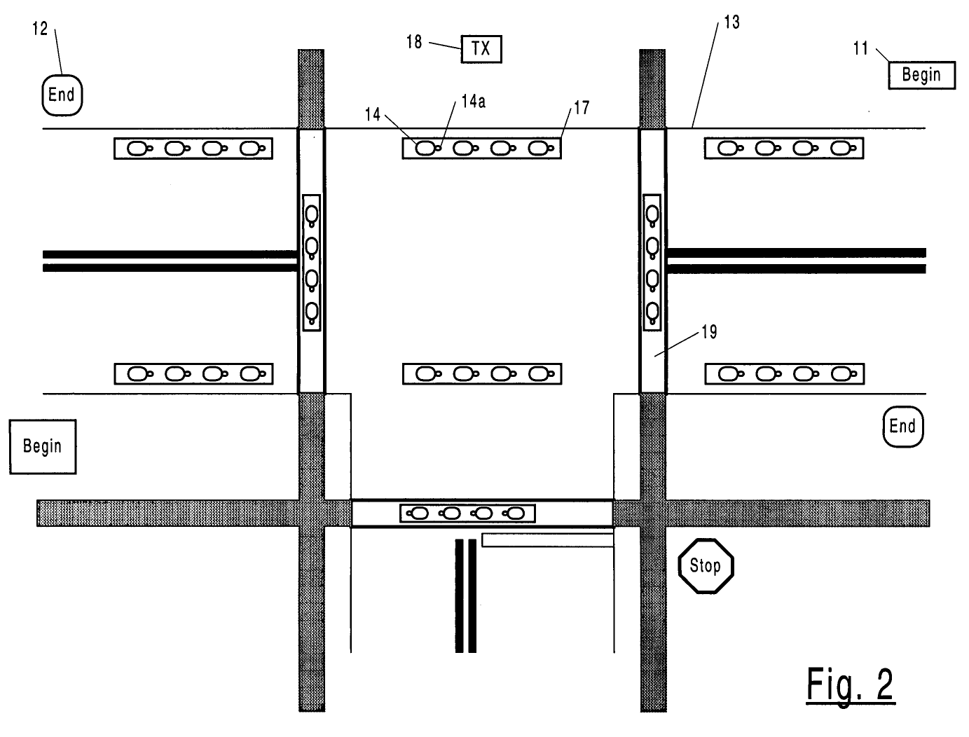

Referring now to FIG. 2, in other embodiments, the lights 14 can be solar powered. In such embodiments, there is no need for a connection/ tap to an external power source, nor any need to connect the lights together in a circuit. In such embodiments, a separate trigger is needed. For this, each light can be equipped with a radio controlled switch 14a. A transmitter 18 can then broadcast a signal that turns all the lights on and another signal that turns all the lights off. The transmitter in such embodiments serves as the trigger.

The lights are preferably an energy-efficient, long-lived light. For example, the lights can be fluorescent, or can be light-emitting diode (LED) lights. Further, although the invention encompasses simple white or yellow lights, the lights can also be other colors, and in particular blue or red. Preferably, the lights have at least some characteristic that varies, in order to attract attention. For example, the lights can vary in intensity, and in particular, the lights can blink on and off. Another possibility is for the lights to change color.

To keep from in any way impairing the vision of pedestrians or motorists, the lights can be selected and arranged so as to provide beams directed substantially straight upwards. Alternatively, the lights can be of a sort that provides low intensity and/or diffuse illumination (not having a beam character), so that a motorist would easily notice when the lights are on, but so that it is not possible for vision to be in any way impaired even when looking directly at the lights.

Although the lights are shown in FIG. 1 near the curb on each side of the road so that there are two strings of lights, another possibility is to provide one string of lights down the middle of the road along the entire length of the reduced speed limit zone. In addition, lights according to the invention are also provided along portions of the length of each crosswalk 19 (FIGS. 1 and 2) in the reduced speed limit zone.

To embed the lights in the road, the same kind of cutting tool can be used as is now used to place sensors in a road in order to control traffic lights. A swathe of asphalt can be cut out of the road, preferably from one to three inches in width, and two to four inches in depth, creating a trough along the length of the reduced speed limit zone, although the trough can be intermittent if solar-power lights are used, so that no connectors 16 are needed. The conductors 16 (possibly in a protective conduit), if needed, and lights 14 in their protective casings 17 can then be placed in the trough. If conductors are used, they can then be covered back up with road surface material (typically asphalt), but of course the lights are left uncovered, in their protective casings.

The invention can obviously be used for providing positive notice along the length of any roadway where a reduced speed limit is in force, not just a school safety zone.

It is to be understood that the above-described arrangements are only illustrative of the application of the principles of the present invention. Numerous modifications and alternative arrangements may be devised by those skilled in the art without departing from the scope of the present invention, and the appended claims are intended to cover such modifications and arrangements.

What is claimed is:

1. A system for indicating where along a length of road a reduced speed limit is in force, comprising:
a plurality of lights (14), disposed from place to place along the length of road and embedded in the road, and whose illumination when turned on varies in some characteristic; and
a trigger (15 18), for turning the lights (14) on when the reduced speed limit is in force.

2. A system as in claim 1, wherein the lights (14) are connected by conductors (16) to each other and to a tap (15) of external electric power serving as the trigger.

3. A system as in claim 1, wherein the lights (14) are solar powered and are radio-controlled by a transmitter (18) serving as the trigger.

4. A system as in claim 1, wherein the varying of some characteristic is a varying of intensity.

5. A system as in claim 1, wherein the varying of some characteristic is a varying of color.
